(19) United States
(12) Patent Application Publication
(10) Pub. No.: US 2014/0318126 A1
(43) Pub. Date: Oct. 30, 2014

(54) PNEUMATIC CYLINDER MODULE FOR A COMBUSTION NAILING TOOL

(71) Applicant: Yimin ZHU, Chongqing (CN)

(72) Inventor: Yimin ZHU, Chongqing (CN)

(21) Appl. No.: 14/254,587

(22) Filed: Apr. 16, 2014

(30) Foreign Application Priority Data
Apr. 25, 2013 (CN) 201310147884.9
Apr. 25, 2013 (CN) 201320216447.3

(51) Int. Cl. B25C 1/08

(52) U.S. Cl. CPC B25C 1/08
USPC 60/632

(57) ABSTRACT

A pneumatic cylinder module includes a cylinder unit, a cylinder head and a sleeve. The cylinder unit includes, a tubular main body, a plurality of angularly spaced-apart and longitudinally extending connecting ribs, and a positioning ring connected to the connecting ribs. The cylinder head is mounted to and covers the positioning ring. The sleeve is sleeved around the cylinder unit, cooperates with the cylinder head and the main body to define a combustion chamber thereamong, and is axially movable relative to the cylinder unit between closed and open positions, where the sleeve seals and allows access to the combustion chamber, respectively.

### CROSS-REFERENCE TO RELATED APPLICATIONS

This application claims priority to Chinese Application Nos. 201320216447.3 and 201310147884.9, filed on Apr. 25, 2013.

### BACKGROUND OF THE INVENTION

1. Field of the Invention

The present invention relates to a combustion nailing tool, more particularly to a pneumatic cylinder module for a combustion nailing tool.

2. Description of the Related Art

A conventional nailing tool usually includes a cylinder body defining an axis, a cylinder head, a plastic housing connecting the cylinder body to the cylinder head along the axis, and a sleeve surrounding the cylinder body and the cylinder head to define a combustion chamber thereamong.

However, the plastic housing is subjected to severe impact attributed to explosion during use of the nailing tool and may therefore deform. Consequently, the cylinder body and the cylinder head that are connected to the deformed plastic housing would offset from the original axis, thus disfavoring accuracy of the nailing tool.

### SUMMARY OF THE INVENTION

Therefore, an object of the present invention is to provide a pneumatic cylinder module for a combustion nailing tool capable of alleviating the aforesaid drawback.

According to the present invention, the pneumatic cylinder module comprises a cylinder unit, a cylinder head and a sleeve. The cylinder unit includes a tubular main body, a plurality of connecting ribs, and a positioning ring. The tubular main body defines a central axis. The connecting ribs are connected to a rear end of the main body at respective angularly spaced-apart positions with respect to the central axis, and extend in a longitudinal direction substantially parallel to the central axis. The positioning ring is coaxial with the main body and is connected to the connecting ribs opposite to the main body. The cylinder head is mounted to and covers the positioning ring opposite to the connecting ribs. The sleeve is sleeved around the cylinder unit, surrounds the connecting ribs, cooperates with the cylinder bead and the main body to define a combustion chamber thereamong, and is movable relative to the cylinder unit along the central axis between a closed position, where the sleeve seals the combustion chamber, and an open position, where the sleeve allows access to the combustion chamber.

### BRIEF DESCRIPTION OF THE DRAWINGS

Other features and advantages of the present invention will become apparent in the following detailed description of the preferred embodiment with reference to the accompanying drawings, of which;

FIG. 1 is a sectional view of a preferred embodiment of the pneumatic cylinder module according to the present invention;

FIG. 2 is a perspective view of a cylinder unit of the preferred embodiment;

FIG. 3 is a perspective view of a cylinder head of the preferred embodiment;

FIG. 4 is a perspective view illustrating the cylinder head positioned on the cylinder unit;

FIG. 5 is a perspective view of a sleeve of the preferred embodiment; and

FIG. 6 is a perspective view illustrating the sleeve being sleeved around the cylinder unit.

### DETAILED DESCRIPTION OF THE PREFERRED EMBODIMENT

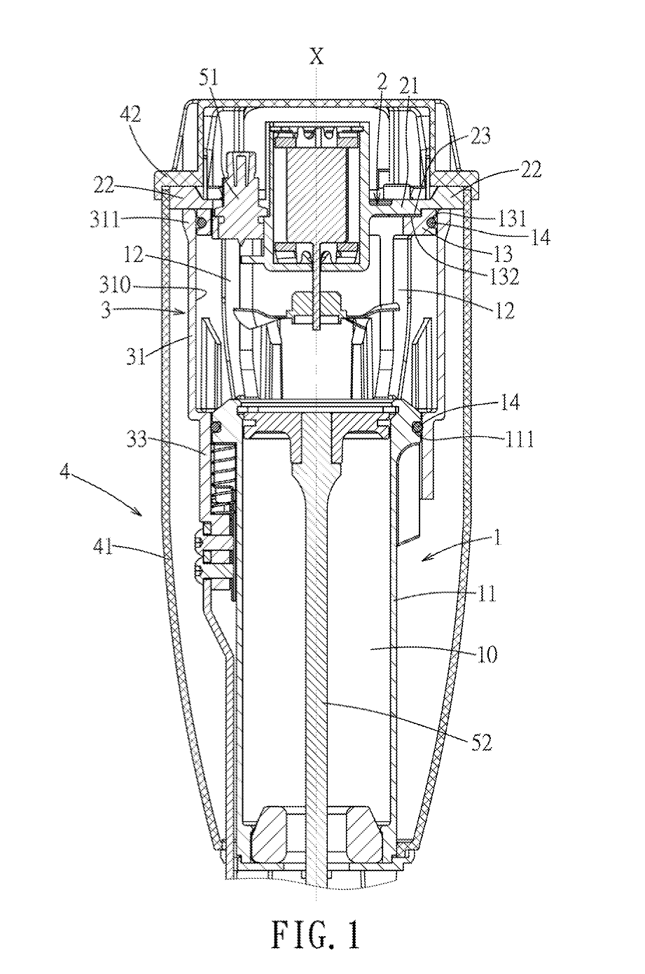

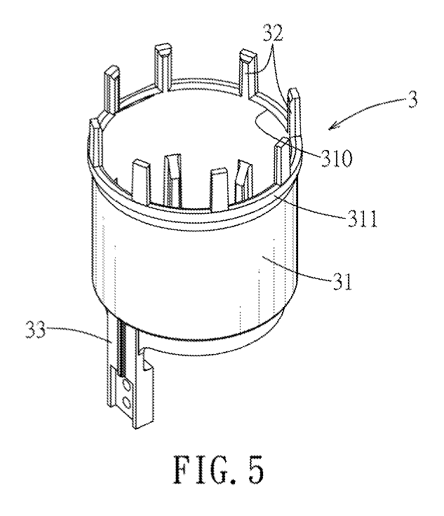

Referring to FIGS. 1 to 6, a preferred embodiment of the pneumatic cylinder module for a combustion nailing tool is shown. The pneumatic cylinder module includes a cylinder unit 1, a cylinder head 2, a sleeve 3, and a heat insulating housing 4.

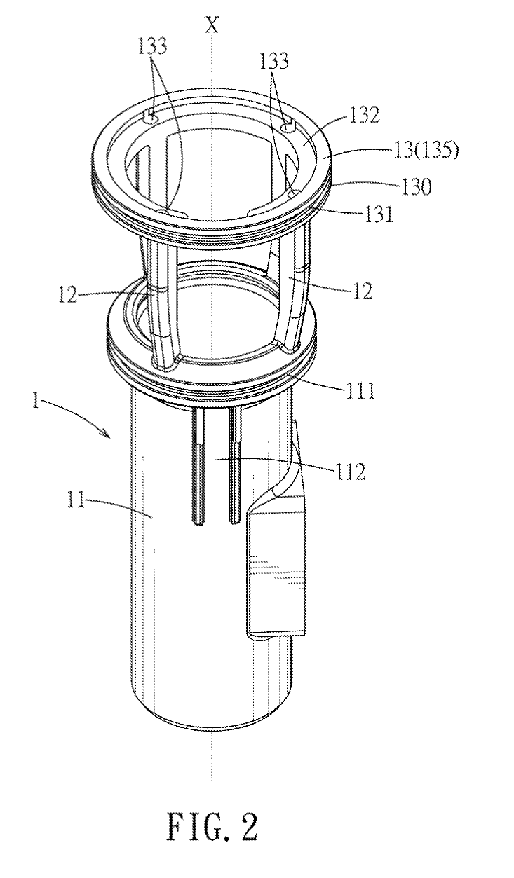

As shown in FIG. 2, the cylinder unit 1 includes a tubular main body 11, a plurality of connecting ribs 12, and a positioning ring 13. The tubular main body 11 defines a central axis (X). The connecting ribs 12 are connected to a rear end of the main body 11 at respective angularly spaced-apart positions with respect to the central axis (X), and extend in a longitudinal direction substantially parallel to the central axis (X). The positioning ring 13 is coaxial with the main body 11, and is connected to the connecting ribs 12 opposite to the main body 11. In this embodiment, the main body 11, the connecting ribs 12 and the positioning ring 13 are integrally formed. Note that the positioning ring 13 has an inner diameter larger than that of the main body 11, which facilitates releasing the cylinder unit 1 from a mold and results in a relatively simple manufacturing process for the cylinder module. The main body 11 of the cylinder unit 1 has an outer surface formed with a first annular slot 111 and a guiding groove 112. The first annular slot 111 is adjacent to the connecting ribs 12 and surrounds the central axis (X). The guiding groove 112 extends in the longitudinal direction.

The positioning ring 13 has a peripheral surface 130 formed with a second annular slot 131, and a rear side surface 135. The second annular slot 131 surrounds the central axis (X). The rear side surface 135 of the positioning ring 13 faces the cylinder head 2, and is formed with a first engaging member 132 configured as a recess in this embodiment. The positioning ring 13 is formed with a plurality or threaded holes 133 extending in the longitudinal direction through the positioning rings 13 into the connecting ribs 12, respectively. The cylinder unit 1 further includes two O-rings 14 (see FIG. 1) received in the first and second annular slots 111, 131, respectively.

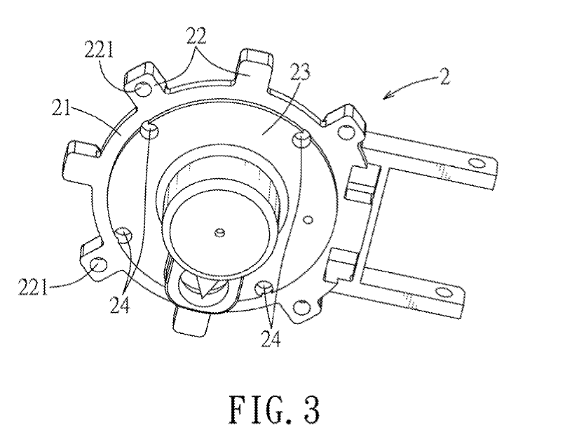

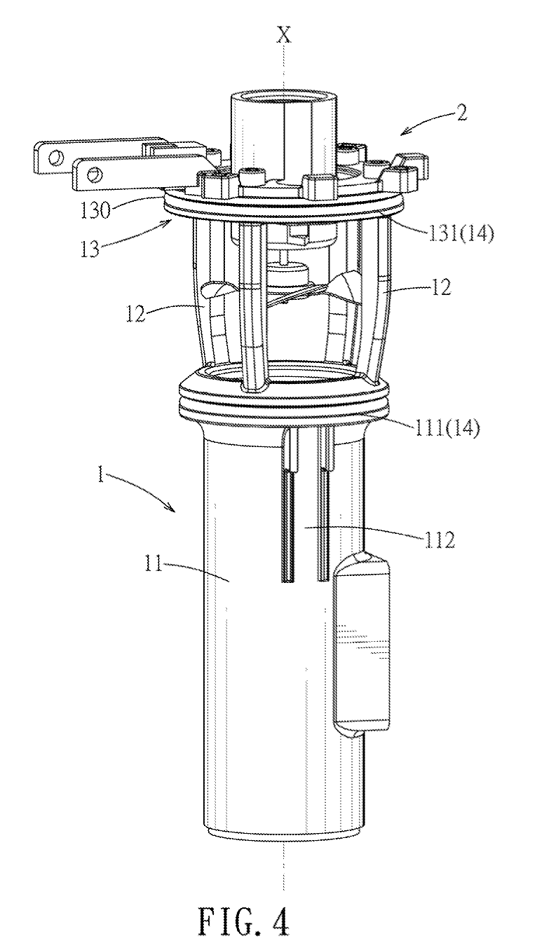

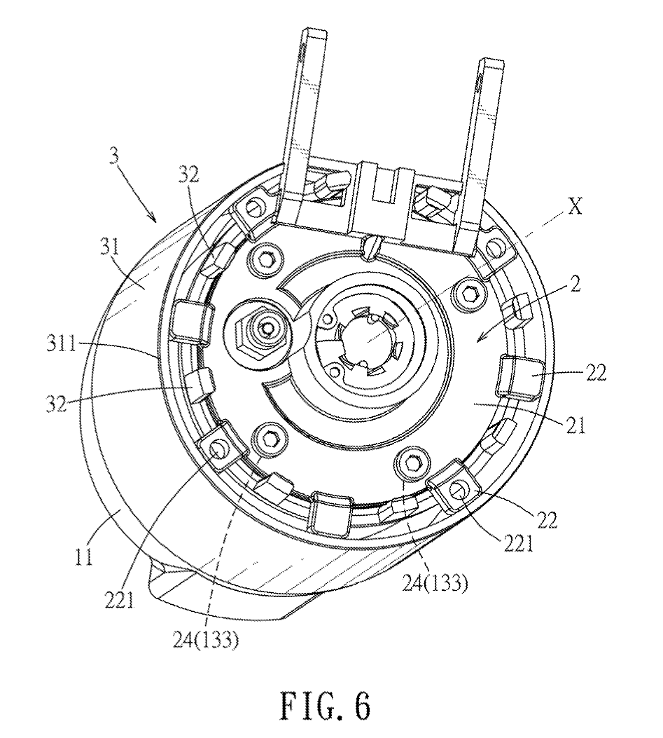

Further referring to FIGS. 3 and 4, the cylinder head 2 includes a circular body 21, a plurality of angularly spaced-apart protrusions 22, and a second engaging member 23. In this embodiment, the second engaging member 23 is configured as a protrusion matching and engaging the first engaging member 132, such that the cylinder head 2 is positioned at the positioning ring 13. The circular body 21 is formed with a plurality of through holes 24 registered respectively with the threaded holes 133 formed in the positioning ring 13. A plurality of screws (see FIG. 6) extend through the through holes 24 and the respective threaded holes 133 to stably connect the cylinder head 2 to the positioning ring 13. The protrusions 22 extend radially and outwardly from a rim of the circular body 21, and some of them are formed with respective threaded holes 221.

Further referring to FIGS. 1, 5 and 6, the sleeve 3 is sleeved around the cylinder unit 1, and cooperates with the cylinder head 2 and the main body 11 to define a combustion chamber 10 thereamong. The sleeve 3 is movable relative to the cylinder unit 1 along the central axis (X) between a closed position, where the sleeve 3 seals the combustion chamber 10, and an open position, where the sleeve 3 allows access to the combustion chamber 10. Note that the sleeve 3 has an inner surface 310 that tightly abuts against the O-rings 14 so as to seal the combustion chamber 10 at the closed position.

The sleeve 3 includes a tube body 31, a reinforcing flange 311, a plurality of limiting arms 32 and a guiding aria 33. The tube body 31 surrounds the connecting ribs 12. The limiting arms 32 extend from a rear edge of the tube body 31 in the longitudinal direction toward the cylinder head 2, surround the cylinder head 2, and are staggered with the protrusions 22 so as to confine movement of the sleeve 3 relative to the cylinder head 2 in the longitudinal direction. The reinforcing flange 311 extends radially and outwardly from the tube body 31, and corresponds to the positioning ring 13 in position when the sleeve 3 is at the closed position. The guiding arm 33 extends from the tube body 31 in the longitudinal direction, and slidably engages the guiding groove 112 formed in the main body 11 of the cylinder unit 1 so as to guide the sleeve 3 to move between the open and closed positions along the central axis (X).

The heat insulating housing 4 includes a housing body 41 and a cover 42. The housing body 41 receives the cylinder unit 1, the cylinder head 2 and the sleeve 3 therein. The cover 42 is disposed at and covers an open end of the housing body 41 that is adjacent to the cylinder head 2. For example, the cover 42 of the heat insulating housing 4 is stably connected to the cylinder head 2 using a plurality of threaded screws, which extend through the cover 42 respectively into the threaded holes 221.

When the sleeve 3 is at the close position and the combustion chamber 10 is sealed by the O-rings 14, flammable gas (such as methane) is introduced into the combustion chamber 10, and then a spark plug 51 ignites mixture of the flammable gas and air in the combustion chamber 10 to generate an explosion, driving a firing pin 52 to fire a nail (not shown). Thereafter, the sleeve 3 is moved to the open position to discharge exhaust gas and to introduce fresh air into the combustion chamber 10 for subsequent use.

To sum up, since the main body 11, the connecting ribs 12 and the positioning ring 13 are integrally formed, reaction force attributed to the explosion may slightly stretch the connecting ribs 12 and may be absorbed thereby, alleviating direct impact on and deformation of the heat insulating housing 4. Accordingly, service life of the pneumatic cylinder module of the present invention may be increased. Further, the configuration of the guiding arm 33 and the guiding groove 112 and the configuration of the limiting arm 32 staggered with the protrusions 22 confine axial movement of the sleeve 3 relative to the cylinder unit 1 and the cylinder head 2 in the longitudinal direction. Thus, a relatively good accuracy of the nailing tool can be achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass ail such modifications and equivalent arrangements.

What is claimed is:

1. A pneumatic cylinder module for a combust ion nailing tool, said pneumatic cylinder module comprising:
a cylinder unit including
a tubular main body defining a central axis,
a plurality of connecting ribs connected to a rear end of said main body at respective angularly spaced-apart positions with respect to the central axis, and extending in a longitudinal direction substantially parallel to the central axis, and
a positioning ring coaxial with said main body and connected to said connecting ribs opposite to said main body;
a cylinder head mounted to and covering said positioning ring opposite to said connecting ribs; and
a sleeve sleeved around said cylinder unit, surrounding said connecting ribs, cooperating with said cylinder head and said main body to define a combustion chamber thereamong, and movable relative to said cylinder unit along the central axis between a closed position, where said sleeve seals said combustion chamber, and an open position, where said sleeve allows access to said combustion chamber.

2. The pneumatic cylinder module as claimed in claim 1, wherein said positioning ring has a rear side surface facing said cylinder head and being formed with a first engaging member, and said cylinder head has a second engaging member matching and engaging said first engaging member, such that said cylinder head is positioned at said positioning ring.

3. The pneumatic cylinder module as claimed in claim 2, wherein one of said first and second engaging members is a recess, and the other one of said first and second engaging members is a protrusion.

4. The pneumatic cylinder module as claimed in claim 1, wherein said sleeve includes a tube body surrounding said connecting ribs, and a plurality of limiting arms extending from a rear edge of said tube body in the longitudinal direction toward said cylinder head and surrounding said cylinder head so as to confine movement of said sleeve relative to said cylinder head in the longitudinal direction.

5. The pneumatic cylinder module as claimed in claim 4, wherein said sleeve further includes a reinforcing flange extending radially and outwardly from said tube body, and corresponding to said positioning ring in position when said sleeve is at the closed position.

6. The pneumatic cylinder module as claimed in claim 4, wherein said main body of said cylinder unit has an outer surface provided with a guiding groove extending in the longitudinal direction, and said sleeve further includes a guiding arm extending from said tube body in the longitudinal direction and engaging said guiding groove slidably so as to guide said sleeve to move between the open and closed positions along the central axis.

7. The pneumatic cylinder module as claimed in claim 1, wherein said main body, said connecting ribs and said positioning ring are integrally formed.

8. The pneumatic cylinder module as claimed in claim 1, wherein said ma in body has an outer surface formed with a first annular slot that is adjacent to said connecting ribs and that surrounds the central axis, and said positioning ring has a peripheral surface formed with a second annular slot that surrounds the central axis, said cylinder unit further including two O-rings received in said first and second annular slots, respectively, said sleeve having an inner surface that tightly abuts against said O-rings so as to seal said combustion chamber at the closed position.

9. The pneumatic cylinder module as claimed in claim 1, wherein
said positioning ring is formed with a plurality of threaded hales extending in the longitudinal direction through said positioning rings into said connecting ribs, respectively, and said cylinder head is formed with a plurality of through holes registered respectively with said threaded holes.

10. The pneumatic cylinder module as claimed in claim 1, further comprising a heat insulating housing that includes:
a housing body receiving said cylinder unit, said cylinder head and said sleeve therein; and
a cover disposed at and covering an open end of said housing body that is adjacent to said cylinder head;
wherein said cylinder head includes a circular body, and a plurality of angularly spaced-apart protrusions extending radially and outwardly from a rim of said circular body.

11. The pneumatic cylinder module as claimed in claim 1, wherein said positioning ring has an inner diameter larger than that of said main body.
